(19) United States
(12) Patent Application Publication
(10) Pub. No.: US 2022/0309879 A1
(43) Pub. Date: Sep. 29, 2022

(54) METHOD AND SYSTEM FOR A SPORTS WAGERING GAME

(71) Applicant: David Candiff, La Crescenta, CA (US)

(72) Inventor: David Candiff, La Crescenta, CA (US)

(21) Appl. No.: 17/657,035

(22) Filed: Mar. 29, 2022

Related U.S. Application Data
(60) Provisional application No. 63/167,466, filed on Mar. 29, 2021.

(51) Int. Cl. G07F 17/32; G06Q 50/34

(52) U.S. Cl. CPC G07F 17/3288; G06Q 50/34

(57) ABSTRACT

A method and system for operating a wagering game. The example wagering game may be based on selecting different players in a sport such as baseball via a user device. The selected players are assigned parts of an achievement, such as the Cycle, in baseball. A bettor wins the wagering game by selecting four players and assigning the correct hits of a cycle (single, double, triple, and home run). The bettor receives a payout for successfully predicting the players and the selected hits of the Cycle.

### PRIORITY CLAIM

This disclosure claims priority to U.S. Provisional Application Ser. No. 63/167,466, filed on Mar. 29, 2022. The contents of that application are hereby incorporated by reference in their entirety.

### TECHNICAL FIELD

The present invention relates generally to sports wagering gaming systems, and more specifically to a game that allows a bettor to select individual players as a group to accomplish a specific athletic goal.

### BACKGROUND

Fan interest in sports has been spurred recently with the advent of fantasy games and attendant websites. Such fantasy games increase interest in sports by allowing users to select certain players or teams and wager on outcomes for the players or teams. However, current applications such as Daily Fantasy Sites and/or Casino Sports Books for sports, such as major league baseball (MLB), do not offer an intuitive game for the wagering fan or even the non-fans. No one has provided a mobile wagering game specific to allowing a bettor to choose combinations of league players to collectively achieve a rare feat.

Thus, there is a need for a mobile based wagering game allowing bettors to wager on an athletic achievement spread over player selected athletes. There is another need for a game that allows bettors to select the athletes from different organizations.

### SUMMARY

According to one example, a computer implemented method for playing a wagering game based on players in a sports league is disclosed. Selections from a user including a set of players and assignments for parts of an achievement in at least one sports contest are received by a user device. A wager input by the user is received by a user device. The user device communicates the selections and the wager input to a server via the internet. The selections and wager input from the user are accepted by the server. The server determines whether the set of players have achieved all parts of the achievement. The server awards a payout based on the wager input if the set of players has achieved all parts of the achievement.

A further implementation of the example method is where the sports league is a baseball league. Another implementation is where the achievement is a cycle of a home run, a triple, a double and a single. Another implementation is where the method further includes limiting a pool of players available for the set of players. Another implementation is where the limiting is one of players on a team, in a game, or in a division. Another implementation is where the method includes displaying a listing of players for selection for the set of players on the user device. The listing of players is provided by the server. Another implementation is where the listing of players includes listing of player data related to the achievement. Another implementation is where the method includes displaying the selected set of players and assignments and updating the status of the selected set of players achieving the parts of the achievement. Another implementation is where the user device is a smart phone.

Another example is a system for operating a wagering game. The system includes a server collecting sports related data and a communications interface to communicate with user devices. The system includes a controller operable to receive a wager to play a wagering game from a user device. The controller receives selections of a set of players and assignments of parts of an achievement to each of the players. The controller determines whether the achievements are achieved via the collected sports related data. The controller sends notification of success for the selected set of players achieving the assigned parts of the achievement. The controller awards a payout to the user device.

Another example is a device for playing a sports wagering game. The device includes a display and a communication interface to receive data from an external server. The device includes a controller operable to display information relating to players in a sports league received from the external server. The controller receives selections from a user including a set of players and assignments for parts of an achievement in at least one sports contest. The controller transmits a wager input and the selections via the communication interface to the external server. The controller receives a notification whether the set of players have achieved parts of the achievement. The controller displays a payout based on the wager input if the set of players has achieved parts of the achievement on the display.

A further implementation of the example device is where the sports league is a baseball league. Another implementation is where the achievement is a cycle of a home run, a triple, a double and a single. Another implementation is where the controller limits a pool of players available for the set of players. Another implementation is where the limiting is one of players on a team, in a game, or in a division. Another implementation is where the controller displays a listing of players for selection for the set of players on the display. Another implementation is where the listing of players includes listing of player data related to the achievement. Another implementation is where the controller further displays the selected set of players and assignments and updates the status of the selected set of players achieving the parts of the achievement on the display. Another implementation is where the device is a smart phone.

Another example is a non-transitory, machine readable medium having stored thereon instructions for operating a wagering game. The stored instructions comprise machine executable code, which when executed by at least one machine processor, causes the machine processor to receive selections from a user including a set of players and assignments for parts of an achievement in at least one sports contest. The code when executed causes the processor to receive a wager input by the user via a user device. The user device communicates the selections and wager input to a server via the internet. The code when executed causes the processor to accept the selections and wager input from the user. The code when executed causes the processor to determine whether the set of players have achieved all parts of the achievement. The code when executed causes the processor to award a payout based on the wager input if the set of players has achieved all parts of the achievement.

The above summary is not intended to represent each embodiment or every aspect of the present disclosure. Rather, the foregoing summary merely provides an example of some of the novel aspects and features set forth herein. The above features and advantages, and other features and advantages of the present disclosure will be readily apparent from the following detailed description of representative embodiments and modes for carrying out the present invention when taken in connection with the accompanying drawings and the appended claims.

### BRIEF DESCRIPTION OF THE DRAWINGS

FIG. 1 is a block diagram of a system that may be used to run an application to collect and broadcast emotional score data from user devices;

FIG. 2 is a block diagram of an example mobile user device for a user that may participate in the collection of emotional score data by the system in FIG. 1;

FIG. 3 is a tree diagram of the interfaces that are generated by an example wagering game application that allows selection of players in a sports league for collectively achieving a feat;

FIG. 4A is a diagram of the options in a dashboard interface for the example wagering game;

FIG. 4B is a screen image of part of the dashboard interface displayed on a mobile device;

FIG. 5A is a screen image of an interface allowing a bettor to select players by team or by statistical breakdown;

FIG. 5B is a screen image of an interface listing players by a certain statistic;

FIG. 5C is a screen image of a selection interface showing players that may be selected to play the wagering game;

FIG. 5D is a screen image of an interface that lists players selected allowing a bettor to submit the players to play the wagering game;

FIG. 5E is a screen image of an interface listing selection of teams;

FIG. 6A is a screen image of a status interface allowing a bettor to view the status of the selected players during the course of the games;

FIG. 6B is a screen image of a results interface that is shown when a bettor is unsuccessful in the wagering game;

FIG. 6C is a screen image of a results interface that is shown when a bettor is successful in the wagering game; and

FIG. 7 is a flow diagram of the routine for executing the example wagering game.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

In this example, a wagering game that allows a bettor to be awarded an award by selecting a set of players in a sports league to achieve a combined achievement is disclosed. The example game may be executed by a mobile device that generates interfaces allowing the user of the mobile device or bettor to select players participating in at least one sports context such as a league game, assign parts of the combined achievement to each of the selected players, and place a wager. In this example, the selection of players may be limited by a team, a division, a league or other subsection of players. For example, a bettor may select baseball players that will each achieve a type of hit (e.g., single, double, triple, home run) constituting a baseball “cycle.” The bettor is awarded a payout if their selections of players collectively hit for the cycle.

An example “Play The Cycle” wagering game is based on players and games managed by Major League Baseball (MLB). Bettors who play the example wagering game can participate with official MLB games, MLB teams and players in a unique game that creates engagements for fans who have never wagered on MLB, as well as more experienced bettors who research MLB stats and outcomes to inform their wagering.

The application can be integrated with mobile devices, laptops, computers, smart TV's, Streaming Services, Digital Boxes and other devices. The game may be played by wagering s relatively small amount such as $1 per play or other total dollar amounts per bettor. One variation for promotional purposes may allow a player to select a specific player and the specific MLB game/date that he will hit for the cycle for winning a jackpot.

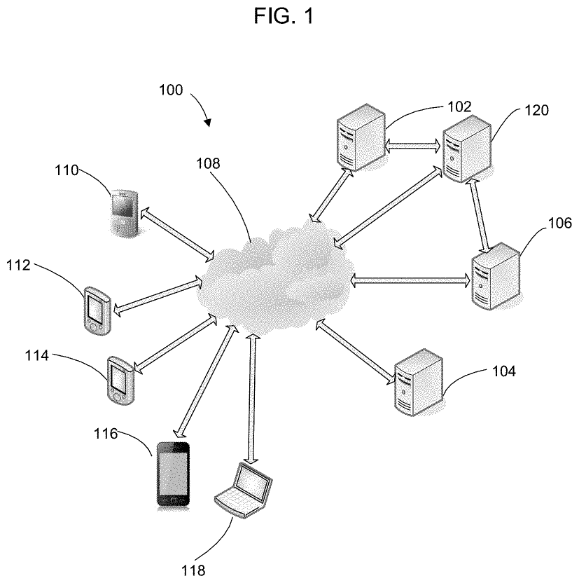

FIG. 1 shows a system 100 for the playing of the example wagering game. The wagering game is administered by a gaming application server 102 that is interfaced with a web server 104 and an application server 106. The web server 104 includes various applications that may be accessed to establish accounts and provide information to potential users for playing the example game. The application server 106 organizes information relevant to the game such as obtaining individual athletic and team data. The application server 106 may also serve as an interface with an external financial institution or institution to handle payment accounts for bettors. Appropriate security measurements may be implemented to protected financial integrity and maintain security.

The server 102 communicates wirelessly through a network 108 to various user devices 110, 112, 114, 116, and 118 in this example. The user devices 110, 112, 114, 116, and 118 are accessible by users and run the game application to collect and broadcast selections as well as facilitate wagering data from the players. The servers 104 and 106 may be in direct communication with the server 102 or they may communicate through the network 108. It is to be understood that two or more computing systems or devices may be substituted for any one of the computing systems or devices in the system 100. Accordingly, principles and advantages of distributed processing, such as redundancy, replication, and the like, also can be implemented, as desired, to increase the robustness and performance of the devices and systems of the system 100.

In this example, certain user devices such as user devices 110, 112, 114, and 116 are generally portable or mobile devices that include geo-referencing hardware and software that allow their location to be known to both their users and the server 102. The geo-referencing hardware and software for locating a particular device in this example is based on the Global Positioning System (GPS), but other geo-referencing systems may be used.

The server 102 is also coupled to a database storage server 120. The database storage server 120 includes user information such as identification data relating to users of the application operated by the server 102 as well as financial data in relation to the bettor account. The database storage server 120 also includes data which relates to sports statistics and game outcomes that is updated via an official source such as the league. The server 102 includes a controller that operates to receive requests to access a user account from a user device. The server 102 records bettor selections and supervises financial transactions with external financial institutions in terms of payouts to the bettors.

The mobile user devices 110, 112, 114 and 116 may include virtually any, preferably, mobile computing device that is configured to send and receive information over a wireless capable network, such as the network 108. In this example, the user devices 110, 112, 114, 116, and 118 are web-enabled and may run browser software for the presentation of web pages to the user. Such mobile user devices 110, 112, 114, and 116 may include portable devices such as cellular telephones, smart phones, display pagers, radio frequency (RF) devices, infrared (IR) devices, global positioning devices (GPS), Personal Digital Assistants (PDAs), handheld computers, wearable computers, tablet computers, smart TV's, Streaming Services, Digital Boxes and other integrated devices combining one or more of the preceding devices, and the like. The user device 118 may be a lap top computer, a desk top computer, a work station or other computer. The user devices 110, 112, 114, 116 and 118 may include multiprocessor systems, microprocessor-based, or programmable consumer electronics, and the like. As such, user devices running the application described below may range widely in terms of capabilities and features.

As exampled below, the web-enabled user devices 110, 112, 114, 116, and 118 may include a browser application enabled to receive and to send wireless application protocol messages (WAP), and/or wired application messages, and the like. The user devices 110, 112, 114, 116, and 118 also include a social scoring application that may be run in conjunction with the browser application. In one example, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and/or send digital information.

The user devices 110, 112, 114, 116, and 118 may also include at least one client application that is configured to receive control data and/or content from another computing device via a network transmission. The client application may include a capability to provide and receive textual content, graphical content, video content, audio content, and the like. Moreover, the user devices 110, 112, 114, 116, and 118 may be further configured to communicate and/or receive a message, such as through a Short Message Service (SMS), direct messaging (e.g., Twitter), e-mail, Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between or with another computing device, and the like.

The network 108 is configured to allow communications between one computing device and another computing device. The network 108 may be enabled to employ any form of computer readable media for communicating information from one electronic device to another. On an interconnected set of LANs, including those based on differing architectures and protocols, a router and/or gateway device acts as a link between LANs, enabling messages to be sent between computing devices. Also, communication links within LANs typically include twisted wire pair or coaxial cable, while communication links between networks may utilize analog telephone lines; full or fractional dedicated digital lines including T1, T2, T3, and T4; Integrated Services Digital Networks (ISDNs); Digital Subscriber Lines (DSLs); wireless links including satellite links; or other communication links known to those of ordinary skill in the art. Furthermore, remote computers and other related electronic devices can be remotely connected to either LANs or WANs via a modem and temporary telephone link.

The network 108 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. The network 108 may also include an autonomous system of terminals, gateways, routers, and the like connected by wireless radio links or wireless transceivers. These connectors may be configured to move freely and randomly and organize themselves arbitrarily, such that the topology of the network 108 may change rapidly and arbitrarily.

The network 108 may further employ a plurality of access technologies including 2nd (2G), 2.5, 3rd (3G), 4th generation (4G), 5^{th} generation (5G) radio access for cellular systems; WLAN; Wireless Router (WR) mesh; and the like. Access technologies such as 2G, 3G, 4G, 5G, and future access networks may enable wide area coverage for mobile devices, such as the user devices 110, 112, 114, 116, and 118, with various degrees of mobility. For example, the network 108 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. The network 108 may also be constructed for use with various other wired and wireless communication protocols, including TCP/IP, UDP, SIP, SMS, RTP, WAP, CDMA, TDMA, EDGE, UMTS, GPRS, GSM, UWB, WiMax, IEEE 802.11x, and the like. In essence, the network 108 may include virtually any wired and/or wireless communication mechanisms by which information may travel between one computing device and another computing device, network, and the like.

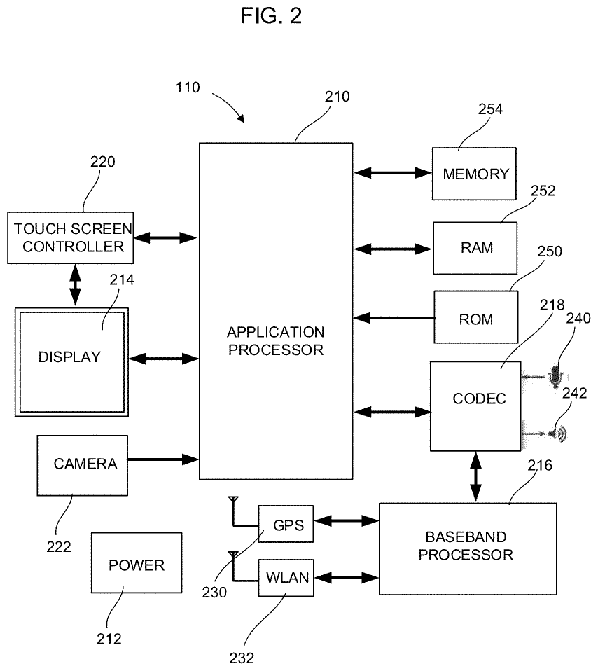

FIG. 2 is a block diagram of the components of a mobile user device such as the mobile user device 110 in FIG. 1. The mobile user device 110 includes an application processor 210, a power source 212, a display 214, a baseband processor 216, and a CODEC 218. In this example, the display 214 is an LCD touch screen that allows the user to control the applications run by the application processor 210 via touch inputs as well as to view graphics generated by the application processor 210. The display 214 is controlled by a touch screen controller 220. The application processor 210 may be coupled to various devices such as a camera 222 and other interfaces such as a communication port, etc.

The baseband processor 216 receives signals from a communication interface such as a network transmitter receiver 230 allowing communications with the network 108 in FIG. 1 and a geo-referencing receiver 232 that allows the reception of positioning data to determine the location of the mobile user device 110. The baseband processor 216 processes in the signals and is coupled to the CODEC 218, which converts the signals for use by the application processor 210. The CODEC 218 also decodes audio signals received by a microphone 240 and encodes data signals for output by a speaker 242 for functions such as a telephone application run by the applications processor 210. Of course other audio devices such as a headset may be coupled through the CODEC 218.

The processors 210 and 216 may be conveniently implemented using one or more general purpose computer systems, microprocessors, digital signal processors, micro-controllers, application specific integrated circuits (ASIC), programmable logic devices (PLD), field programmable logic devices (FPLD), field programmable gate arrays (FPGA), and the like, programmed according to the teachings as described and illustrated herein, as will be appreciated by those skilled in the computer, software, and networking arts.

The operating system software and other applications are stored on read only memory (ROM) 250, random access memory (RAM) 252 and a memory storage device 254 for access by the applications processor 210. In this example, the memory storage device 254 is flash memory, but other memory devices may be used. The applications stored on the memory storage device 254 are instructions including machine executable code which when executed by a machine processor such as a controller cause the machine processor to perform application functions. One stored application includes the example gaming application, which creates interface graphics on the display of the user device. Of course other applications may incorporate the principles explained below. In this example, the gaming application may be preloaded on the mobile user device 110, or may be offered as an application that may be downloaded to the mobile user device 110 from a network device such as the server 102 via the network 108.

The memory storage device 254 includes a non-transitory, machine-readable medium on which is stored one or more sets of instructions (e.g., software) embodying any one or more of the methodologies or functions described herein. The instructions may also reside, completely or at least partially, within memory storage device 254, the ROM 250, the RAM 252, and/or within the processors 210 or 216 during execution thereof by the mobile user device 110. The instructions may further be transmitted or received over a network such as the network 108 in FIG. 1 via the network transmitter receiver 230. While the machine-readable medium is shown in an example to be a single medium, the term “machine-readable medium” should be taken to include a single medium or multiple media (e.g., a centralized or distributed database, and/or associated caches and servers) that store the one or more sets of instructions. The term “machine-readable medium” can also be taken to include any medium that is capable of storing, encoding, or carrying a set of instructions for execution by the machine and that cause the machine to perform any one or more of the methodologies of the various embodiments, or that is capable of storing, encoding, or carrying data structures utilized by or associated with such a set of instructions. The term “machine-readable medium” can accordingly be taken to include, but not be limited to, solid-state memories, optical media, and magnetic media.

A variety of different types of memory storage devices, such as a random access memory (RAM) or a read only memory (ROM) in the system or a floppy disk, hard disk, CD ROM, DVD ROM, flash, or other computer readable medium that is read from and/or written to by a magnetic, optical, or other reading and/or writing system that is coupled to the processor, may be used for the memory or memories in the user device 110.

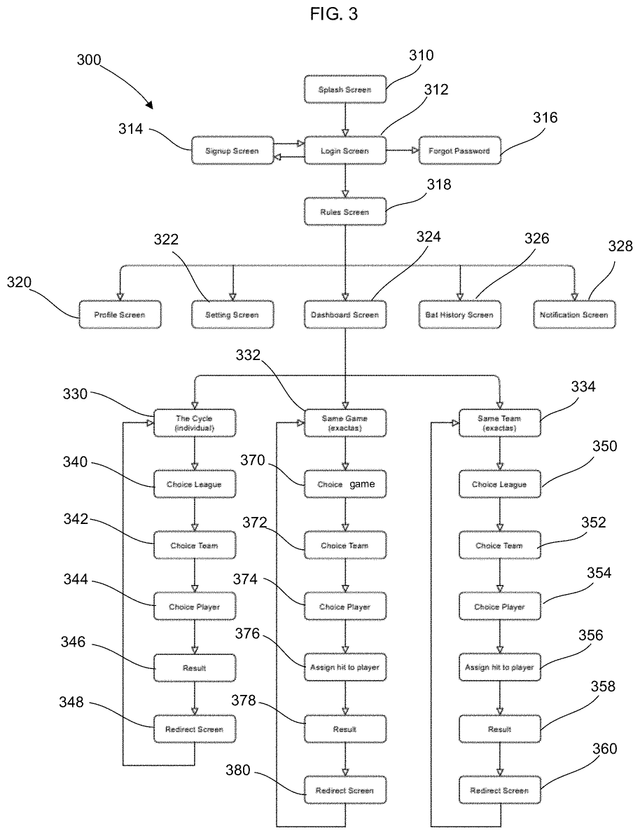

FIG. 3 is a tree diagram 300 of the interfaces generated by the wagering game application that may be executed by the user device 110. As explained above, the wagering application takes inputs from the bettor and obtains relevant data from the server 102 for play of the wagering game and managing a user or bettor account. The application has a default splash screen interface 310 that is displayed when the application is activated on the user device 110. The splash screen interface 310 typically includes an introduction sequence presenting the wagering game and graphics to attract potential bettors. The splash interface 310 may include promotional media such as videos, relevant information such as game rules, and the like. The splash screen interface 310 allows a bettor to enter their identification credentials if the through a login screen interface 312 if the bettor already has an account. The splash interface screen 310 will allow a bettor to navigate to a signup screen interface 314 to create an account. After creation of the account, the bettor will be directed toward the login screen interface 312. If the bettor has forgotten their password or user name, they are directed toward a forget password interface 316.

After a successful login, the bettor will be directed toward a rules screen interface 318. The rules screen interface 318 allows a bettor to access a profile screen 320, a setting screen 322, a dashboard screen 324, a bat history screen 326, and a notification screen 328. In this example, the bat history screen 326 shows a predetermined number of the top batters in a particular league. Alternatively, the history screen 326 may show players in order of other relevant statistics such as by the most hits, doubles, triples, home runs, or slugging percentage. The dashboard screen 324 allows the bettor to play the example wagering game. In this example, the bettor may select different groupings such as all players, same game, or same team for the pool of players the bettor will assign four different types of hits to. Thus, in this example, the dashboard screen 324 allows a user to select an individual via an individual game screen 330, a same team via a team game screen 332, or a same game via a same game screen 334.

The individual game screen 330 may be used for a promotional game in this example. The individual game screen 330 allows navigation to a choose league screen 340. The choose league screen 340 displays two league choices. After the bettor selects a league, a choose team screen 342 is displayed that allows the bettor to select a team in the selected league. After a team has been selected, a choose player screen 344 is displayed that lists all players on the selected team. The promotional game allows a bettor to choose one player to hit for the cycle via the choose player screen 344. The application will receive game statistical data for the selected player and display a result screen 346. The result screen 346 will notify the bettor whether they have won or lost. The result screen 346 will then give the bettor a selection to play the game again. The application then displays a redirect screen 348 that cycles back to the individual game screen 330 if the bettor desires to play the individual game again.

The same team screen 332 allows navigation for a choose league screen 350. The choose league screen 350 displays two league choices. After the bettor selects a league, a choose team screen 352 is displayed that allows the bettor to select a team in the selected league. After a team has been selected, a choose player screen 354 is displayed that lists all players on the selected team. The choose player screen 354 allows a bettor to choose four players. An assignment screen 356 allows a bettor to assign a type of hit to each of the players selected in the choose player screen 354. The application will receive game statistical data for the selected player and display a result screen 358. The result screen 358 will notify the bettor whether they have won or lost. The result screen 358 will then give the bettor a selection to play the game again. The application then displays a redirect screen 358 that cycles back to the individual team screen 332 if the bettor desires to play the individual game again.

The same game screen 334 allows navigation for a choose game screen 370. The choose league screen 370 displays the games that will be played for the day. After the bettor selects a game, a choose team screen 372 is displayed that allows the bettor to select a team in the selected game. After a team has been selected, a choose player screen 374 is displayed that lists all players on the selected team. The choose player screen 374 allows a bettor to choose four players. An assignment screen 376 allows a bettor to assign a type of hit to each of the players selected in the choose player screen 374. The application will receive game statistical data for the selected player and display a result screen 378. The result screen 378 will notify the bettor whether they have won or lost. The result screen 378 will then give the bettor a selection to play the game again. The application then displays a redirect screen 380 that cycles back to the individual game screen 330 if the bettor desires to play the choose game option again.

Similar sequences to those shown in screens 370-380 may be displayed for the same division or same league options of the example wagering game. Similar sequences may be displayed for other limitations for player selections in the example wagering game.

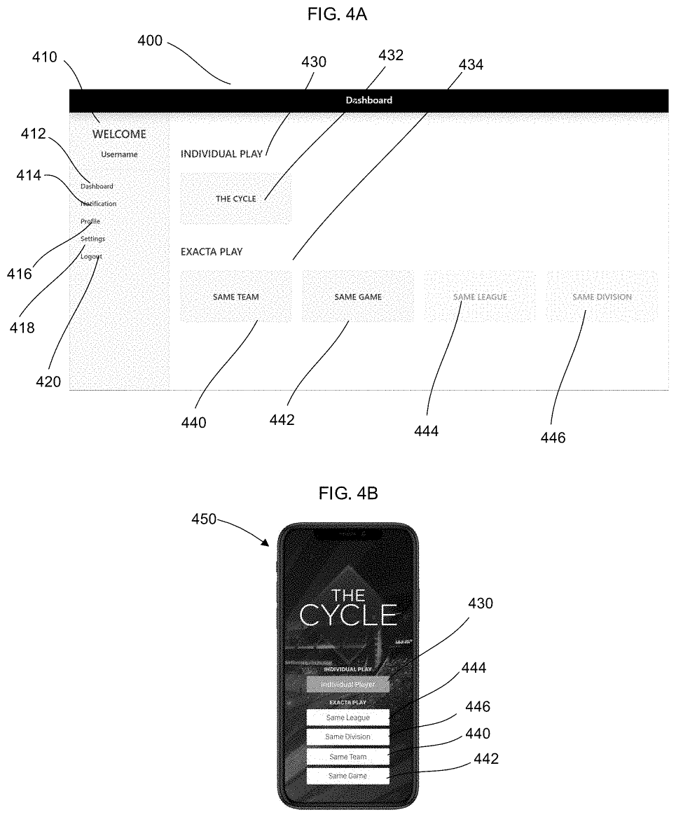

FIG. 4A is a diagram of the features of a dashboard user interface 400 that includes the initial options available to a bettor of the example wagering game. The dashboard interface 400 may be displayed after a player is authenticated based on entry of a user name and password. Other security measures may be provided. The user interface 400 shows the user name that is selected by the bettor when setting up an account to play the example wagering game. The user interface 400 has a menu area 410 that includes a dashboard selection 412, a notification selection 414, a profile selection 416, a settings selection 418, and a log out selection 420.

The notification selection 414 displays a screen with relevant updates from the games played by the players in the sport. For example, the notification screen may display live score updates, final score results, upcoming games and the like. The profile selection 416 allows a bettor to change their profile such as changing contact information, nickname, financial data, and the like. The settings selection 418 allows a bettor to change application settings such as an option to include multiple bets, repeating a wager for another series of games, and the amount bet. The logout selection 420 allows the bettor to log out from the application.

A player may register for the wagering game application and select a password as well as information allows selection for transferring and receiving payments for game play. The bettor creates an account and escrow account for transaction of currency for wagers and winnings. This account may be a block chain or crypto currency account defined by a wagering actor such as a casino. The account may also be linked to conventional financial accounts such as a payment service, bank or credit/debit card vendor.

Selection of the dashboard 412 allows a user to display a navigation area 430 that allows navigation to selection interfaces. FIG. 4A shows the selection of the dashboard selection 412 to display the navigation area 430. In this example, the navigation area 430 allows a player to select between an individual play button 432 or an exacta play 434 by selecting one of a series of exacta play buttons 440, 442, 444, 446. As will be explained individual play is activated by selecting the individual play selection button 432. Exacta play is a more difficult challenge where a bettor is limited by the players on a certain team via the button 440, a certain game via the button 442, a certain division via the button 446, or a certain league via the button 444.

FIG. 4B is a screen image 450 showing the interface 400 in FIG. 4A displayed on a mobile device such as the mobile user device 110 in FIG. 1. The screen image 450 allows a user to select an individual play or an exacta play in the navigation area 430. Specifically, the player may select the individual play button 432 or one of four exacta play buttons 440, 442, 444, or 446.

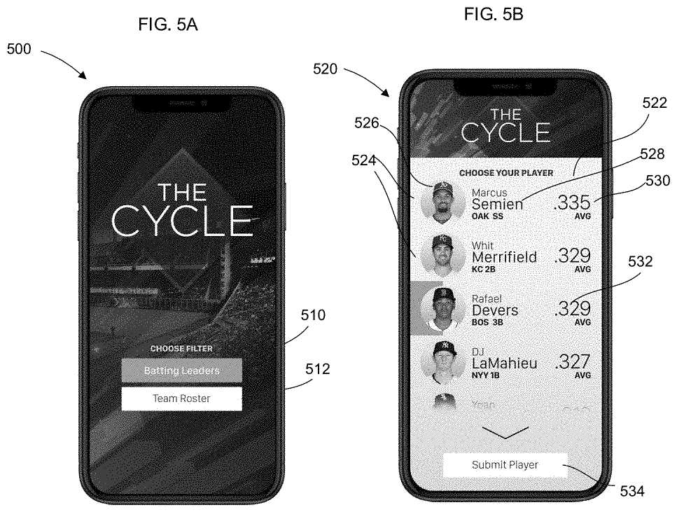

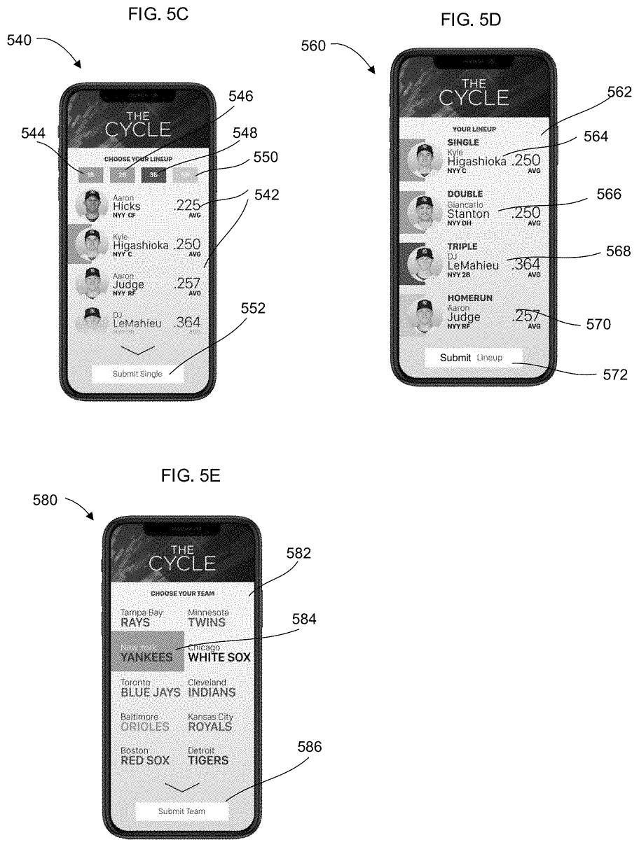

FIG. 5A shows a screen image of a filter interface 500 that is displayed when a bettor desires to wager on an individual play by selecting the individual play button 432 in FIG. 4A. The filter interface 500 allows a player to list players by a relevant statistic such as batting average by selecting a leaders selection button 510. The filter interface also includes a team roster selection button 512 that allows the listing of players by their respective teams. The review batting leaders selection 510 may be tailored to allow a bettor to list the players based on other relevant sports statistic such as batting average, slugging percentage, number of home runs, number of triples, number of doubles, number of singles, and the like. The listing may also be provided for the particular week of games, month of games, or overall season.

FIG. 5B is a screen image of a player listing interface 520 that includes a player list 522 of player rows 524 based on the button 510 or 512 selected by the bettor in FIG. 5A. In this example, the bettor selected the leaders selection button 510 and thus players are listed by their batting average. Each player listing row 524 shows a picture of the player 526, identification information 528, such as the name, team and position of the player, and the batting average of the player 530. In this example, the players are listed from the highest batting average to the lowest batting average. A player on the list 522 may be selected by outlining the player on the player listing such as the player listing row 530 and hitting a submit player button 534.

Once a player is selected via the submit player button 534 a player selection interface 540 is displayed as shown in FIG. 5C. The player selection interface 540 lists all eligible players on the team in alphabetical order. A player listing 542 includes the picture of the player, identification information, and batting average. A bettor may assign one of the four hits to four selected players via selecting a player in the listing 542 and hitting one of four hit buttons 544, 546, 548, and 550. When a player is selected via one of the hit buttons 544, 546, 548, and 550, the player listing is highlighted in a color associated with the specific selected hit. If the bettor desires to lock in the selections, the player may select a submit button 552.

FIG. 5D shows a summary interface 560 displayed once one or more players are selected by the bettor. The summary interface 560 shows a listing of players 562. In this example, the bettor has chosen four players, and thus four player summaries 564, 566, 568, and 570 are shown Each player summary 564, 566, 568, and 570 has a color that indicates the hit that they have been selected for by the bettor. The summary interface includes a confirm line up button 572 allows the bettor to place their wager. Once the confirm line up button 572 has been selected, the application will inform a bettor of a successful wager if the four selected players hit for the selected type of hits that constitute the cycle. When the bettor wins, the credited amount is deposited in the player's account or sent to an external financial account.

As explained above, a bettor may also select players by a team for the individual play by selecting the team selection button 440 in FIG. 4A. FIG. 5E shows a resulting team selection interface 580 that is displayed when the team selection button 440 in FIG. 4A is selected. The team selection interface 582 includes a listing of all teams with selection buttons 584. A bettor may select a team by a selection button associated with that team. A submit team button 586 will result in the display of a team player selection interface similar to the 540 shown in FIG. 5C that lists all eligible players on the team in alphabetical order.

Similar to the player selection interface 540, each player listing includes the picture of the player, identification information, and batting average. A bettor may assign one of the four hits to four selected players via selecting a player in the listing and hitting one of four hit buttons. When a player is selected via one of the hit buttons, the player listing is highlighted in a color associated with the specific selected hit.

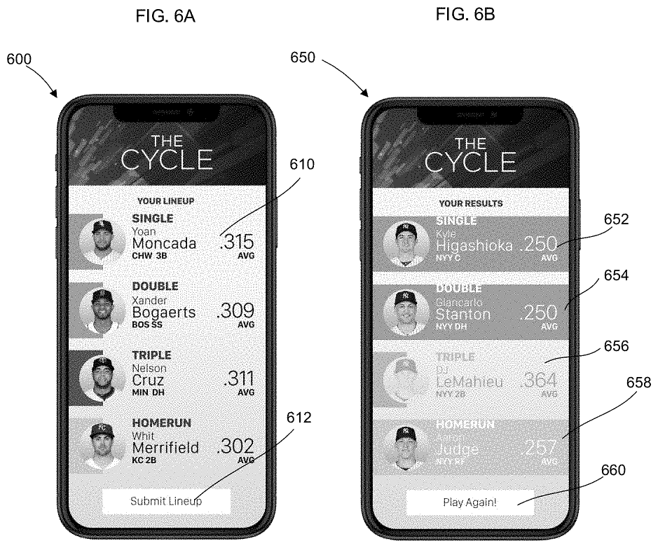

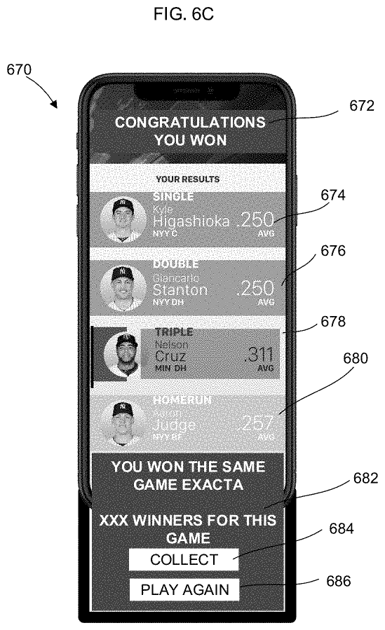

FIG. 6A shows a submission status screen image 600 shown once the selected four players are chosen by the player and confirmed. As explained, the players may be selected by team or by a listing of player ordered by a statistic. The submission screen image 600 includes a listing of players 610 that are each color coded according to the type of hit assigned to the player. Each player listing 610 will be updated once any of the players hits the assigned hit. The real-time game data may be sent by the external server to the user device. The achievement of a player may be shown by providing the specific player listing entirely in the color corresponding with the assigned hit such as shown in the listings 610. If a player fails to achieve the assigned hit, the listing may be grayed out. The listing may include other real-time information or game information such as whether the player is batting or the results of past at bats. Such information may be included in the listing of the players or may be accessed via the notifications tab 414 in FIG. 4A. Such notifications may include a summary of the player's at bats in a game as well as the inning of the game.

Once the games played by the selected players have been concluded, a results interface is shown. FIG. 6B shows a screen image of a results interface 650 when the bettor is unsuccessful. The results interface 650 includes a listing of four selected players 652, 654, 656, and 658. Each player listing 652, 654, 656, and 658 shows whether the selected player hit the assigned hit. This may be shown by providing the specific player listing entirely in the color corresponding with the assigned hit such as shown in the listings 652, 654, and 658. If a player fails to achieve the assigned hit, the listing may be grayed out as shown in the listing 656. The listing 650 thus shows the results. Since one of the selections did not hit the assigned hit, the bettor did not win. A play again button 660 may be selected to return to the dashboard interface in FIG. 3B to play again.

FIG. 6C shows a screen image 670 of a result interface showing that the bettor has been successful and thus will receive a payout of an award. The interface 670 displays a message 672 that congratulates the bettor. The interface 670 also displays a listing of the four selected players 674, 676, 678, and 680 and the hits that each player achieved. A summary message 682 indicates the type of exacta the bettor won as well as the number of winners that won an award for that type of exacta such as the same game exacta. Other information may be displayed that may show the amount won. A collect button 684 allows the bettor to authorize credit of the award to the associated financial account. Alternatively, when the bettor wins, the associated account may be automatically credited the determined payout. A play again button 686 may be selected to return to the dashboard interface in FIG. 3B to play again.

In this example, if a bettor wagers $2, and selects four players that hit the cycle, they are awarded a set award. The award may be a set amount such as $10,000 or may be determined by the probability of the selected players achieving the parts of the cycle. Other ways may include splitting an overall prize pool among all winning players for a particular game day, a particular week or a particular season.

Each of the exactas in FIG. 4A allow a bettor to select players to hit for different hits in the cycle from smaller groupings of players. In this example, there are four exactas where a bettor picks four players from the same team, same game, same division or same league. Each of the different exact Exacta games have pre-determined prize amounts. Since the available players are fewer, the payoffs for each of the exactas are greater than the individual play. The concept of the Exacta games may be expanded for different time periods. For example, the wagering game may be played over a full season or a half season for a team, a division, or a league, or a series of games between two selected teams.

The first exacta is picking four players from an individual team. In this example game, the player selects the league, the games, and then the specific teams. The interface displays a roster for the selected teams. The bettor then selects four players and assigns the type of hit to the selected player.

For example, when a bettor selects the team exacta by selecting the sane team button 440 in FIGS. 4A and 4B, the bettor may select four players from one team and assign the four hits. Thus, a team selection screen similar to the interface 570 in FIG. 5E would be displayed. Once a team is selected, the bettor is shown a player selection screen similar to the interface 580 in FIG. 5F. Once the players are selected, a confirmation interface similar to the confirmation interface 600 in FIG. 6A is displayed. In this example, the team exacta pays an exact amount and thus if the bettor wagers $2 and picks four players from a team in a game and their individual hits for “the cycle” during a specified game, the bettor is awarded $25 k.

When the bettor selects the same game exacta option 442 in FIG. 4A or 4B, a game selection interface is shown that shows each game for the day. The bettor selects a game. An interface showing all of the players on either team in the game is then displayed similar to the interface 580 in FIG. 5F. The bettor may select four players from either team in the game to assign each of the four hits. Once the players are selected, a confirmation interface similar to the confirmation interface 600 in FIG. 6A is displayed. In this example, the game exacta pays an exact amount and thus if the bettor wagers $2 and picks two players from each of the opposing teams in a game and their individual hits for “the cycle” during a specified game, the bettor is awarded $50 k.

When the bettor selects the same division exacta option 446 in FIG. 4A or 4B, a division selection interface is shown that shows each division and corresponding teams in the division for the day. The bettor may select a team in the division via an interface similar to the interface 570 in FIG. 5E. Once a team is selected, the bettor is shown a player selection screen similar to the interface 580 in FIG. 5F. The bettor may select four players from any of the teams in the division to assign each of the four hits. Once the players are selected, a confirmation interface similar to the confirmation interface 600 in FIG. 6A is displayed. In this example, the team exacta pays an exact amount and thus if the bettor wagers $2 and picks four players from four different teams in the same division and their individual hits for “the cycle” during a specified game, the bettor is awarded $5 k.

When the bettor selects the same league exacta option 444 in FIG. 4B, a league selection interface is shown that shows the different leagues. Once a league is selected, the players active in that league and games for that day are displayed. The bettor selects four players from the league playing that day to assign each of the four hits. Once the players are selected, a confirmation interface similar to the confirmation interface 600 in FIG. 6A is displayed. In this example, the same league exacta pays an exact amount and thus if the bettor wagers $2 and picks players from one of the leagues and their individual hits for “the cycle” during a specified game, the bettor is awarded $10 k.

One promotion that may be offered on the dashboard interface 400 in FIG. 4A is the selection of an individual player to hit for the cycle. Thus, a bettor may pick one player and the specific game that the player will hit for the cycle. This promotion uses the player selection interface described above but rather than assigning individual hits, the player is only selected. The promotion may offer a large prize (e.g. $1 million) and thus incentivize bettors to play the wagering game. An individual player selection interface allows a bettor to select one player for the promotions. Once selected, a player interface may be displayed includes the picture of the player, individual identification information (name, position, and team), and the batting average of the player. The player interface includes a set of indicators corresponding a single, double, triple or home run. Each indicator may be given a color to differentiate the type of hit to track the status of the selection of the player in the promotion.

The example wagering game may also be applied for selecting sets of players on individually, on teams, in games, in a division, or in a league for a series, a half season, a full season, or the post season. The example wagering game may also be applied to other baseball leagues such as minor league baseball, the Nippon League, the KBO League, or the Chinese Professional Baseball League. The example wagering game may apply for other achievements that may be jointly accomplished by different players. For example, in baseball, the wagering game may be modified for selecting four players to hit home runs during a day or another period of the season. The concepts herein may also be applied for achievements in other sports such as golf (selecting players for Par, Birdie, Eagle, Bogie on a hole, a round or a tournament) or basketball (selecting players for double digit steals, assists, 3 pointers in a game).

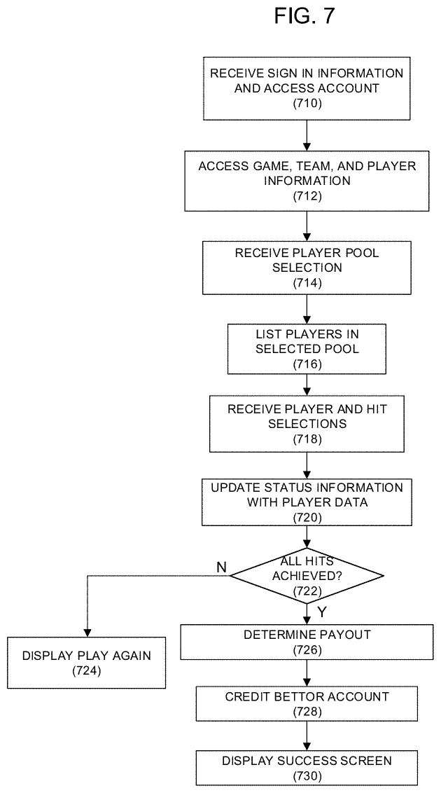

The operation of the example system 100 shown in FIG. 1, which may be controlled on the example server and user devices, will now be described with reference to FIG. 1 in conjunction with the flow diagram shown in FIG. 7. The flow diagram in FIG. 7 is representative of example machine readable instructions for implementing the application to operate the wagering game. In this example, the machine readable instructions comprise an algorithm for execution by: (a) a processor, (b) a controller, and/or (c) one or more other suitable processing device(s). The algorithm may be embodied in software stored on tangible media such as, for example, a flash memory, a CD-ROM, a floppy disk, a hard drive, a digital video (versatile) disk (DVD), or other memory devices, but persons of ordinary skill in the art will readily appreciate that the entire algorithm and/or parts thereof could alternatively be executed by a device other than a processor and/or embodied in firmware or dedicated hardware in a well-known manner (e.g., it may be implemented by an application specific integrated circuit (ASIC), a programmable logic device (PLD), a field programmable logic device (FPLD), a field programmable gate array (FPGA), discrete logic, etc.). For example, any or all of the components of the interfaces could be implemented by software, hardware, and/or firmware. Also, some or all of the machine readable instructions represented by the flowchart of FIG. 7 may be implemented manually. Further, although the example algorithm is described with reference to the flowcharts illustrated in FIG. 7, persons of ordinary skill in the art will readily appreciate that many other methods of implementing the example machine readable instructions may alternatively be used. For example, the order of execution of the blocks may be changed, and/or some of the blocks described may be changed, eliminated, or combined.

FIG. 7 is a flow diagram for the process of executing the example wagering game. The application first reads player identification input and accesses the player financial account (710). The application then accesses relevant game, team, and player information for the games scheduled for the day (712). The application then accepts an input from the player for a type of pool for players to be accepted (714). In this example, the players that may be selected may be limited by all the players playing during a particular day, a team, teams in a game, a division, or a league. The application then lists all of the players that may be selected given the input restrictions (716). The application receives the bettor input of the selection of players and assignment of type of hit (718).

The application then updates the status interface with whether the selected players have achieved their assigned type of hit (720). The application determines whether the selected players have achieved the selected achievements such as the type of hit (722). If any of the selected players fail, the application displays a play again interface (724). If the selections have been successful, the application determines the applicable payout (726). The application then credits the bettor account for the prize amount (728). The application then displays a success interface that indicates that the bettor has won and the amount won (730).

As used in this application, the terms “component,” “module,” “system,” or the like, generally refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller, as well as the controller, can be a component. One or more components may reside within a process and/or thread of execution, and a component may be localized on one computer and/or distributed between two or more computers. Further, a “device” can come in the form of specially designed hardware; generalized hardware made specialized by the execution of software thereon that enables the hardware to perform specific function; software stored on a computer-readable medium; or a combination thereof.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein. While various embodiments of the present invention have been described above, it should be understood that they have been presented by way of example only, and not limitation. Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

What is claimed is:

1. A computer implemented method for playing a wagering game based on players in a sports league, the method comprising:
receiving, by a user device, selections from a user including a set of players and assignments for parts of an achievement in at least one sports contest;
receiving, by a user device, a wager input by the user, the user device communicating the selections and wager input to a server via the internet;
accepting, by the server, the selections and wager input from the user;
determining, by the server, whether the set of players have achieved all parts of the achievement; and
awarding, by the server, a payout based on the wager input if the set of players has achieved parts of the achievement.

2. The method of claim 1, wherein the sports league is a baseball league.

3. The method of claim 2, wherein the achievement is a cycle of a home run, a triple, a double and a single.

4. The method of claim 1, further comprising limiting a pool of players available for the set of players.

5. The method of claim 4, wherein the limiting is one of players on a team, in a game, or in a division.

6. The method of claim 1, further comprising displaying a listing of players for selection for the set of players on the user device, the listing of players provided by the server.

7. The method of claim 6, wherein the listing of players includes listing of player data related to the achievement.

8. The method of claim 1, further comprising displaying the selected set of players and assignments and updating the status of the selected set of players achieving the parts of the achievement.

9. The method of claim 1, wherein the user device is a smart phone.

10. A system for operating a wagering game, the system comprising:
a server collecting sports related data;
a communications interface to communicate with user devices;
a controller operable to:
receive a wager to play a wagering game from a user device;
receive selections of a set of players and assignments of parts of an achievement to each of the players;
determining whether the achievements are achieved via the collected sports related data;
send notification of success for the selected set of players achieving the assigned parts of the achievement; and
awarding a payout to the user device.

11. A device for playing a sports wagering game, the device comprising:
a display;
a communication interface to receive data from an external server; and
a controller operable to:
display information relating to players in a sports league received from the external server;
receive selections from a user including a set of players and assignments for parts of an achievement in at least one sports contest;
transmit a wager input and the selections via the communication interface to the external server;
receive a notification whether the set of players have achieved parts of the achievement; and
displaying a payout based on the wager input if the set of players has achieved parts of the achievement on the display.

12. The device of claim 11, wherein the sports league is a baseball league.

13. The device of claim 12, wherein the achievement is a cycle of a home run, a triple, a double and a single.

14. The device of claim 11, wherein the controller limits a pool of players available for the set of players.

15. The device of claim 14, wherein the limiting is one of players on a team, in a game, or in a division.

16. The device of claim 11, wherein the controller displays a listing of players for selection for the set of players on the display.

17. The device of claim 16, wherein the listing of players includes listing of player data related to the achievement.

18. The device of claim 11, wherein the controller further displays the selected set of players and assignments and updates the status of the selected set of players achieving the parts of the achievement on the display.

19. The device of claim 11, wherein the device is a smart phone.

20. A non-transitory, machine readable medium having stored thereon instructions for operating a wagering game, the stored instructions comprising machine executable code, which when executed by at least one machine processor, causes the machine processor to:
receive selections from a user including a set of players and assignments for parts of an achievement in at least one sports contest;
receive a wager input by the user via a user device, the user device communicating the selections and wager input to a server via the internet;
accept the selections and wager input from the user;
determine whether the set of players have achieved all parts of the achievement; and
award a payout based on the wager input if the set of players has achieved all parts of the achievement.
